(19) United States
(12) Patent Application Publication
(10) Pub. No.: US 2013/0111734 A1
(43) Pub. Date: May 9, 2013

(54) Method of attaching a blast shield to a space frame vehicle

(71) Applicants: Richard L. Allor, Livonia, MI (US); Thomas J. Husak, Roseville, MI (US); Dainius E. Skiotys, Farmington Hills, MI (US); Richard F. Taylor, Waterford, MI (US)

(72) Inventors: Richard L. Allor, Livonia, MI (US); Thomas J. Husak, Roseville, MI (US); Dainius E. Skiotys, Farmington Hills, MI (US); Richard F. Taylor, Waterford, MI (US)

(73) Assignee: Ceradyne, Inc.

(21) Appl. No.: 13/373,228

(22) Filed: Nov. 8, 2011

(51) Int. Cl. B23P 11/00

(52) U.S. Cl. 29/525.02

(57) ABSTRACT

A method to attach a V-shaped or parabolic-shaped blast shield or other blast shields, to the bottom of a vehicle space frame that serves the purpose of redirecting the blast forces away from the crew compartment of the vehicle. Inner beams that run the length or width of the blast shield, align with the space frame running in the same direction. The beams are attached with bolts going through the top of each beam and into a threaded boss welded in the space frame. To attach the sides of the blast shield to the space frame, a rail adapter bracket mounts to the bottom of the space frame that has threaded bosses welded into the space frame. Slotted holes for forward and back and side-to-side adjustment on an adapter bracket are employed to help attach the blast shield to the space frame.

### BACKGROUND OF THE INVENTION

1. Field of the Invention

The present invention relates generally to the field of armor for the protection of passengers of a military vehicle. The invention relates more specifically to a method for installing a blast shield to the bottom surface of military vehicles to protect passengers against IEDs.

2. Background Discussion

It has been evident that in the wars in the Mideast, our military vehicles need a redesign to the bottom of the vehicle to protect for the new threat of Improvised Explosive Devices (IEDs). One of the first V-shaped blast hall designs was used by the South African military in the 1980s. It was specifically designed to maximize passenger survivability for conventionally laid mines. The V-shape is designed to redirect the blast out and away from the vehicles passenger's area. The vehicle may be disabled by the IED, but passengers will survive the blast.

It is easy to design a new vehicle with a V-shaped blast shield. All of the new MRAP vehicles, Mine Resistant Ambush Protected, are equipped with the V-hull and most new vehicles coming out today from all suppliers have them. A large problem is attaching the V-shaped blast shield to vehicles that are already in service. One such vehicle is the Humvee because it rides closer to the ground and has a flat bottom. There are over 16,000 armored Humvees in Iraq today with over 100,000 Humvees worldwide. This makes them vulnerable to the IEDs. Today the military is adding armor to the sides, but no blast protection to the flat bottom of the vehicle. In the present invention we have developed a method to attach a blast shield to a space frame vehicle body. This may be applied to a newly designed vehicle or one that's already in service. The Defense Department is getting ready to terminate a large vehicle program, Joint Light Tactical Vehicle, which was to replace the Humvee fleet. This will mean that there are about 64,000 Humvee's considered too young for the scrap heap.

### SUMMARY OF THE INVENTION

The present invention comprises a method to attach a -V-shaped or parabolic-shaped blast shield or other types of designs of blast shields to the bottom of a space frame that serves the purpose of redirecting the blast forces away from the crew compartment of a vehicle.

A space frame is a tubular system that could be round, square or rectangular and has an outside dimension and an inside dimension with a given wall thickness. This space frame is attached to the vehicle rails. The blast shield is attached to the space frame of the vehicle.

The invention employs inner beams that run the length or width of the blast shield that match up with the space frame running in the same direction. The inner beams are attached with bolts going through the top of the center beam and into a threaded boss welded in the space frame. The boss could be mig welded, tig welded, friction stir welded or using any other known welding process. The inner beam could be made from flat material, or from tubing. In either case, crush zones are designed into the beam to help absorb the blast energy and to assist in the installation. The bottom of the beam employs holes to attach the blast shield to the beam. The blast shield is attached with bolts that are threaded in “J” nuts, cage nuts or weld nuts.

To attach the sides of the blast shield to the space frame a rail adapter bracket mounts to the bottom outer edge of the space frame that has threaded bosses welded into the space frame. For height adjustment a thickness shim can be placed between the bracket and the space frame as needed. Slotted holes for forward and back and side-to-side adjustment on an adapter brackets make it easier to attach the blast shield to the space frame.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a schematic front view showing a blast shield installed on the bottom of a vehicle for redirecting blast energy away from the crew compartment of a vehicle;

FIG. 2 is a more detailed view of a blast shield/vehicle space frame interconnection employed in a preferred embodiment of the present invention;

FIG. 3 is an enlarged view illustrating the bolting scheme for connecting the blast shield to the vehicle space frame by employing an inner beam attached by bolts going through welded threaded bosses;

FIG. 4 is a view showing the structure of an inner beam for absorbing blast energy;

FIG. 5 better illustrates the interconnection between the blast shield and the beam of FIG. 4;

FIG. 6 comprising FIGS. 6A and 6B provides views of an alternative embodiment of an inner beam for use in the present invention;

FIG. 7 illustrates the outer mounting scheme that may be employed in attaching the blast shield and including an adapter plate for adjustment in height;

FIG. 8 illustrates the use of slotted adapter plates for a preferred embodiment that permits lateral and longitudinal adjustment to facilitate field installation of the blast shield; and

FIGS. 9A and 9B provide enlarged views of respective adapter plates of FIG. 8 and corresponding adjustment slots.

### DETAILED DESCRIPTION OF PREFERRED EMBODIMENTS

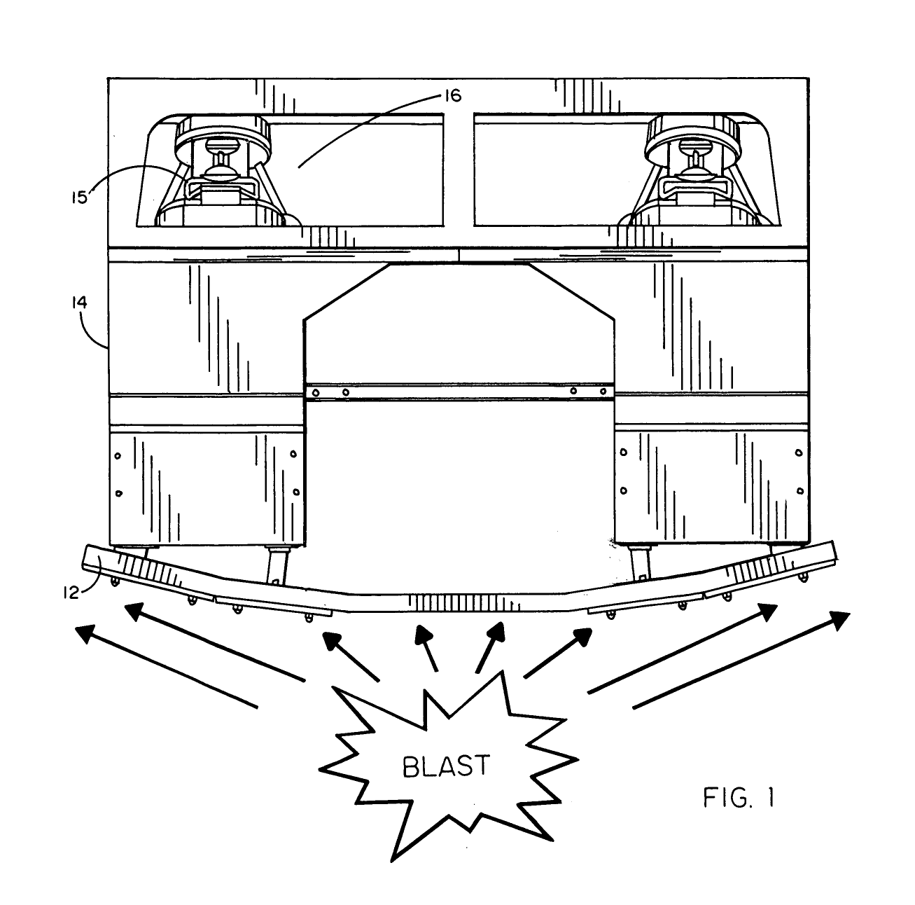

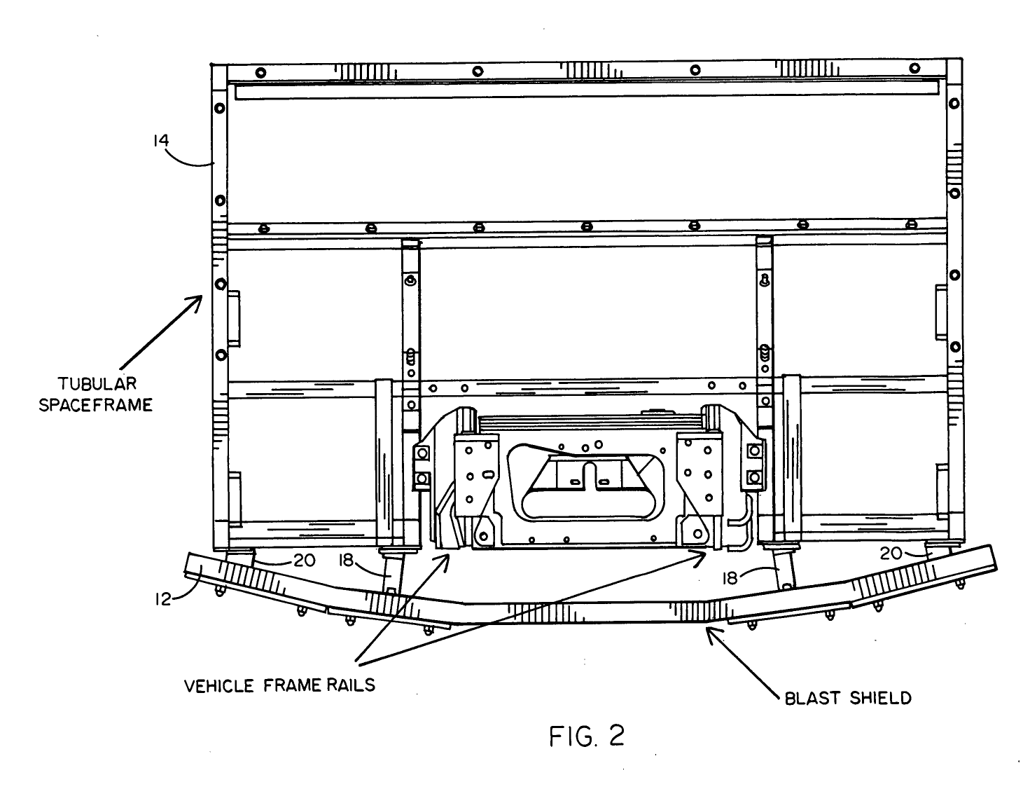

Referring to the accompanying drawings, it will be seen that a generally parabolic-shaped blast shield 12 is attached to a vehicle frame 14 to protect occupants 15 of the vehicle's interior compartment 16 as shown in FIG. 1. As shown in FIG. 2, the blast shield 12 is physically attached to the space frame 14 of the vehicle by a pair of inner mounting beams 18 and by a pair of outer mounting brackets 20. These beams and brackets function as interface members to permit bolting of the blast shield to the vehicle space frame so that field installation is made possible.

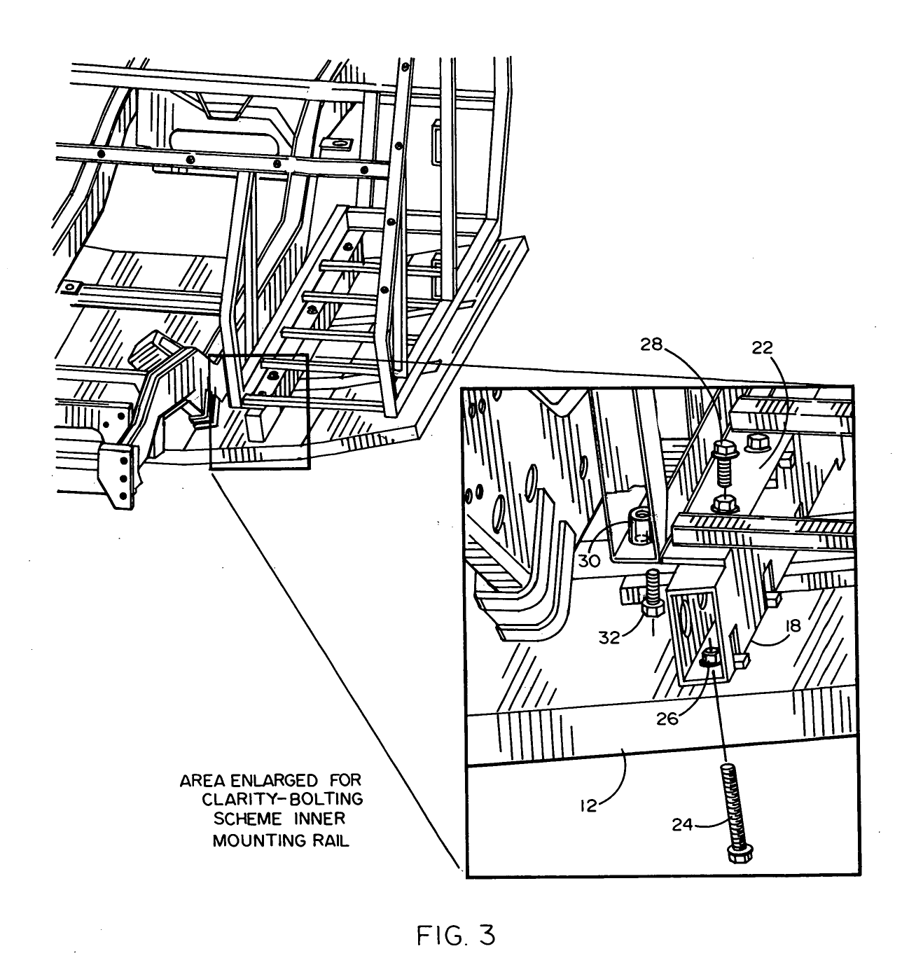

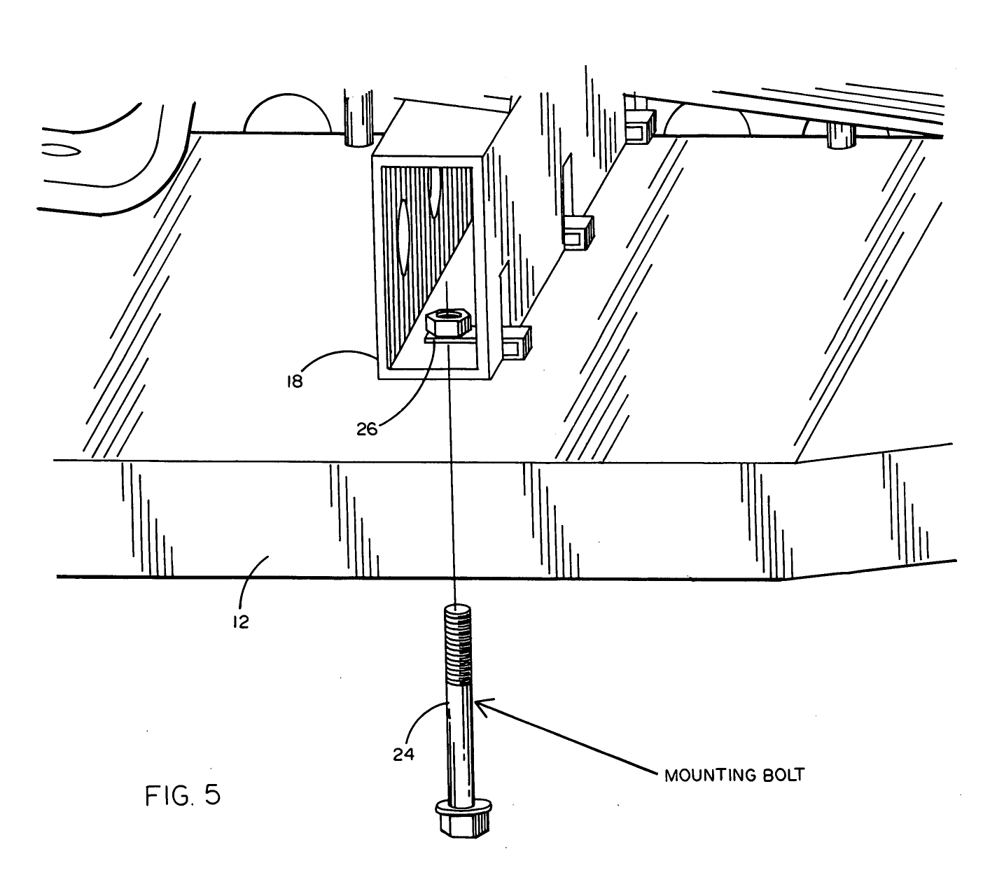

Turning to FIGS. 3-6, it will be seen that each inner mounting beam 18 is secured to an adapter plate 22 which serves the dual function of interconnecting to the space frame 14 and providing some adjustment to ease alignment. More specifically, as seen best in FIG. 5, the inner mounting beam 18 is bolted to the blast shield 12 by bolts 24 extending upwardly and threaded into “J” nuts, cage nuts or weld nuts 26. The top of the beam 18 is attached to adapter plate 22 by bolts 28 extending in a downward direction. The adapter plate is, in turn, connected by bolts 32 received into threaded bosses 30 which are mig welded, tig welded or friction stir welded, or using other known welding processes, into the space frame 12.

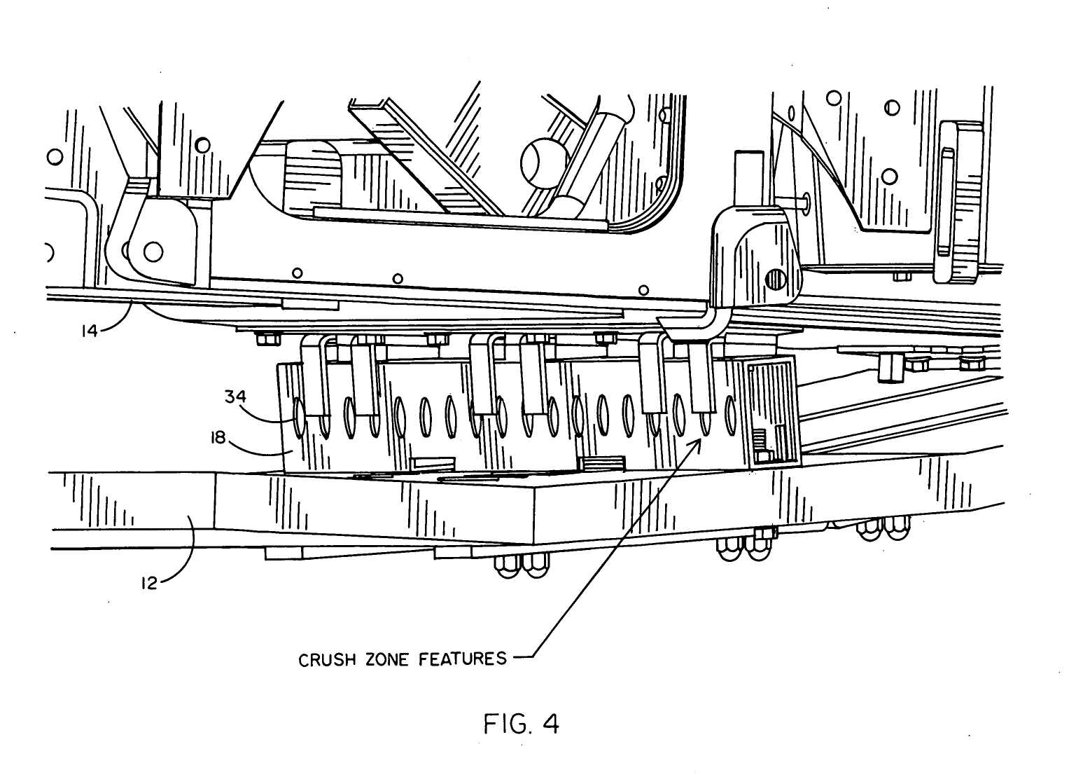

The inner beams 18 serve the principal purpose of providing a bolting system to interconnect the blast shield and the vehicle space frame. However, because the inner beams are preferably tubular, they also provide a way to dissipate blast energy by collapsing in response to a sharp spike in pressure from a blast beneath the blast shield. An additional view of the inner beam 18 shown installed between the blast shield 12 and the tubular space frame 14, is provided in FIG. 4. As seen therein, the inner beam 18 is provided with a plurality of circular apertures 34 which enable the energy absorbing collapse of the beam during a blast of an IED below the vehicle. FIG. 5 shows in a somewhat enlarged view how the inner beam is secured to the underlying blast shield using a plurality of “J” clip nuts 26 and a plurality of elongated bolts 24 which extend through the shield and into the bottom surface of the beam.

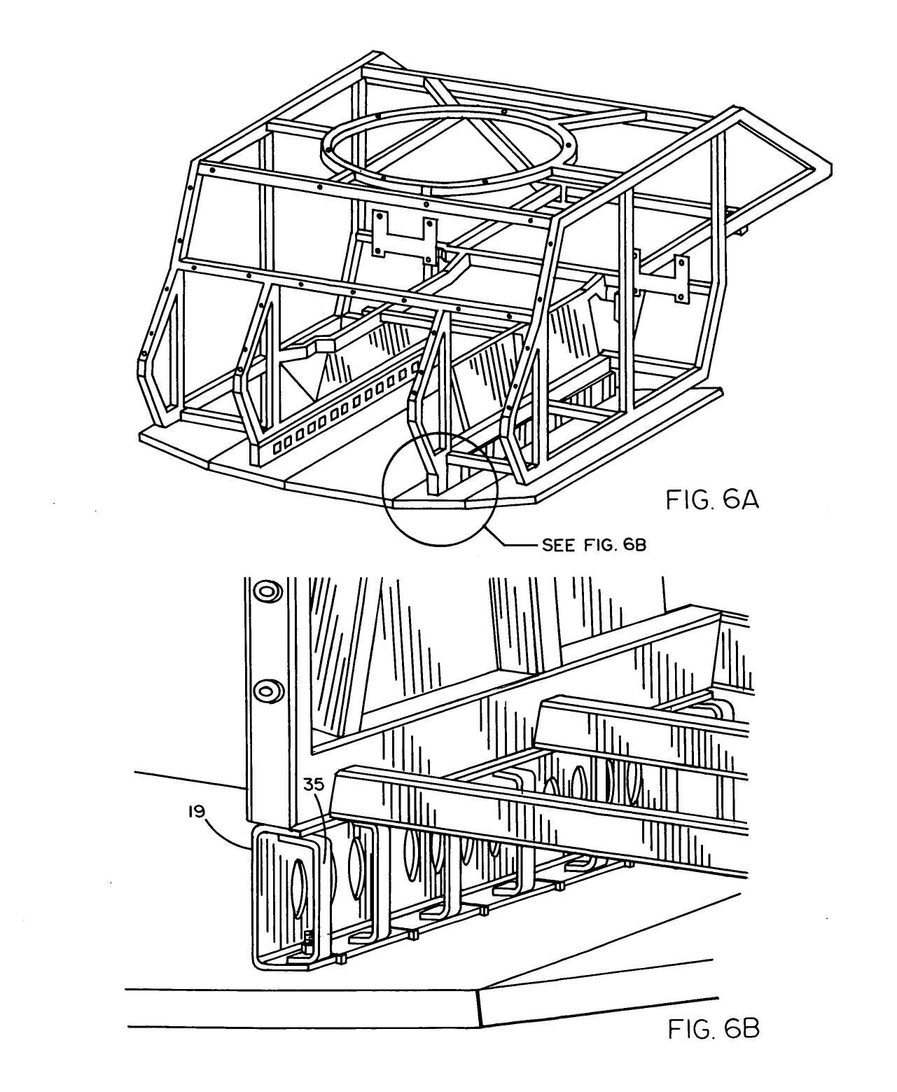

FIG. 6 comprising FIGS. 6A and 6B, shows another embodiment of the inner beam namely, beam 19 which comprises one side of the box structure of beam 18. The other side of the beam is replaced by a plurality of welded C-shaped members 35. This alternative configuration of inner beam 19, reduces weight and promotes a more reliable collapse during the blast. FIG. 6 illustrates an alternative blast shield configuration comprising a plurality of planar members interconnected at I-beam interfaces.

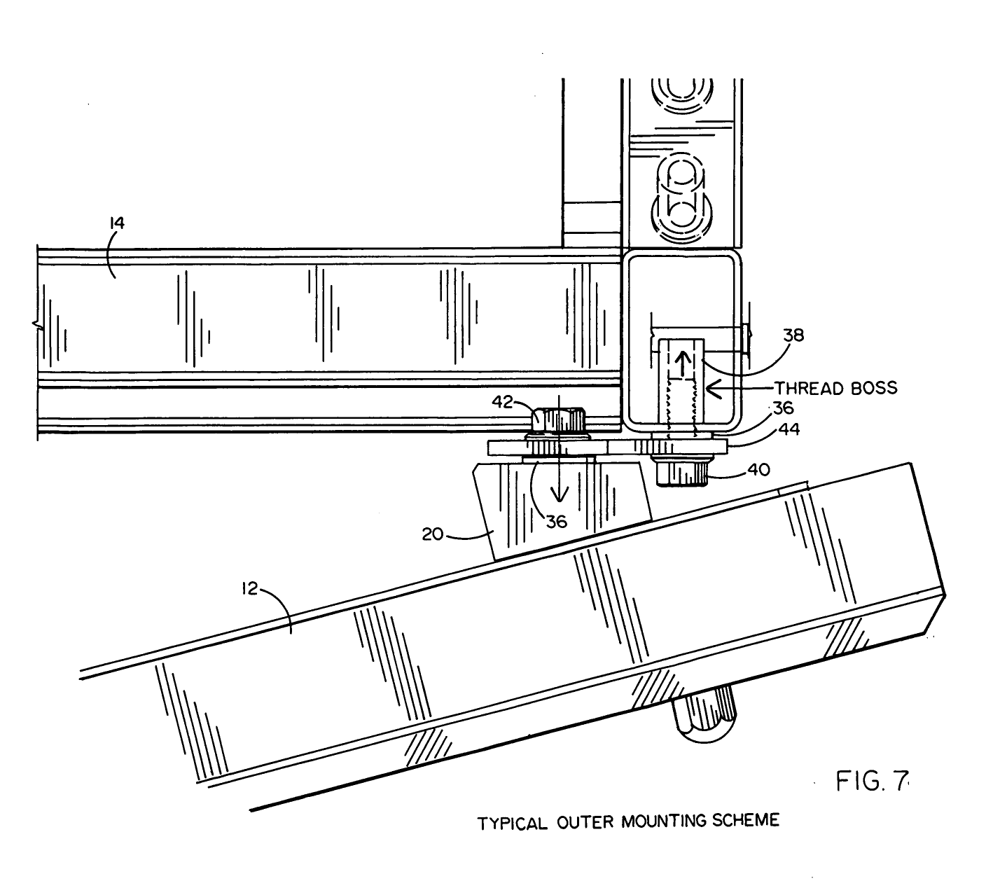

The outer edges of the blast shield 12 are preferably also connected to the vehicle space frame in order to provide a stable and secure interface. A typical outer mounting scheme is shown in FIG. 7. As seen in that figure, an outer bracket 20 is interposed between the blast shield and the space frame. Adapter plate 44 may be employed to fine tune the blast shield position to prevent interference with vehicle structure. Thickness shims 36 may be employed to fine tune the blast shield on both sides of the adapter plate 44 as needed to prevent interference. A threaded boss 38 is welded into the space frame to receive a bolt 40 through the adapter plate 44 and a bolt 42 is employed to secure the adapter plate 44 and bracket 20 to the blast shield.

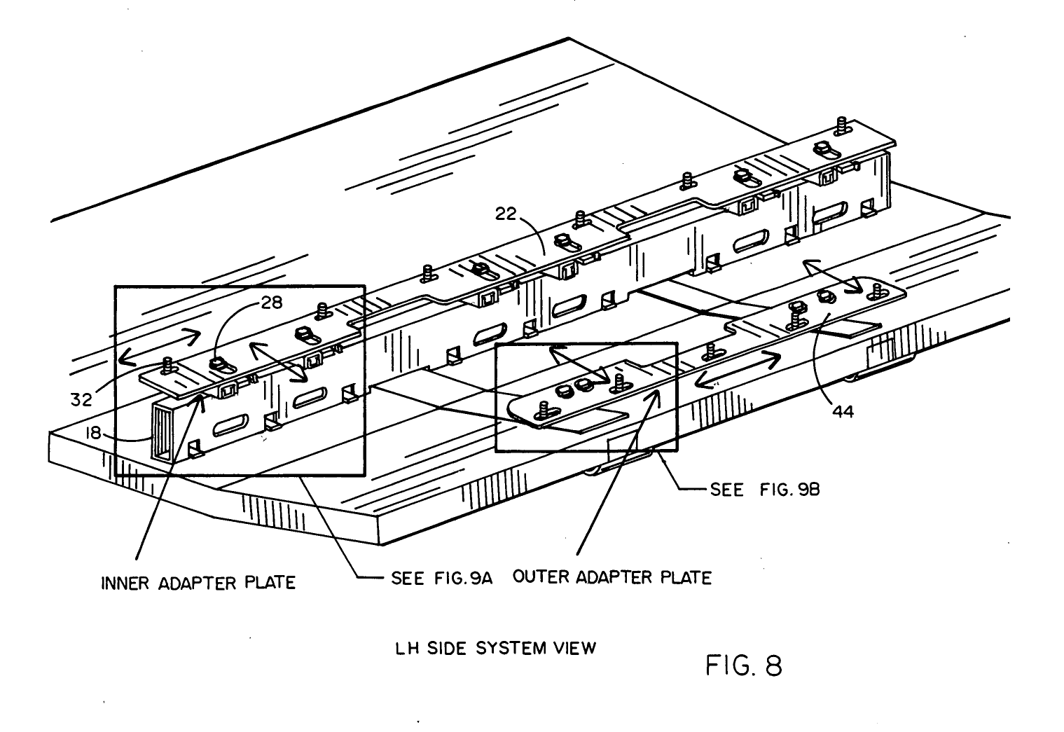

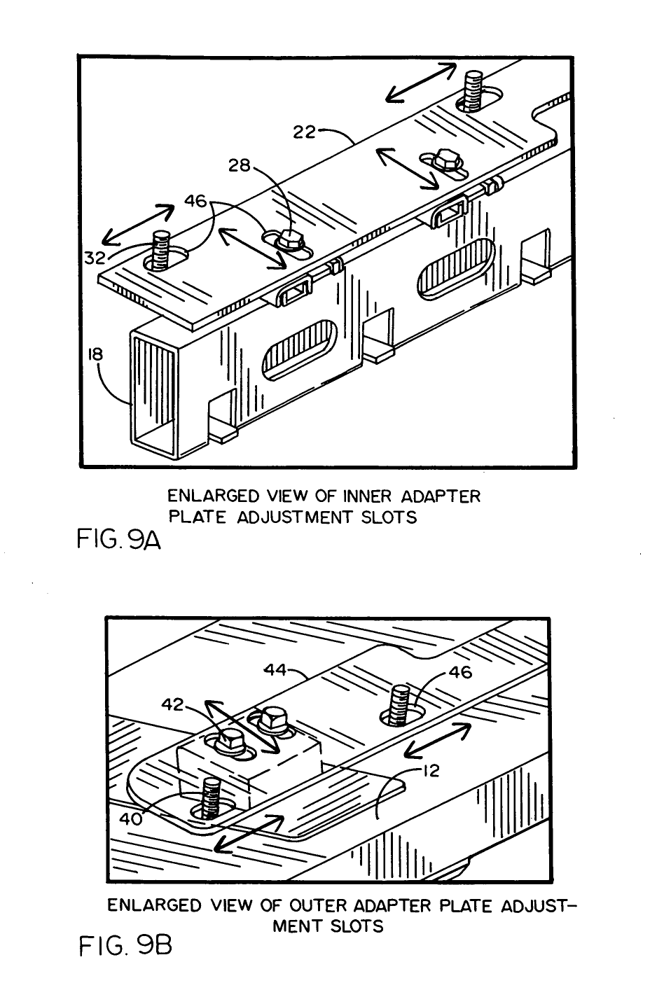

FIGS. 8, 9A and 9B illustrate the use of adapter plates 22 and 44 for aligning interconnecting bolts with threaded bosses in the space frame to allow easy interface in the field. Each such plate has a number of elongated slots 46 to permit independent bolt alignment in X and Y directions during installation.

Based upon the foregoing disclosure, it will now be evident that the present invention comprises a method for attaching a shaped blast shield to the bottom of a vehicle having a space frame and that the preferred embodiment of such a method is especially suited to implementing such attachment subsequent to deployment of the vehicle in the field. Although specific embodiments are described, it will be readily apparent that variations and modifications thereof are likely to be perceived based upon the inventive features hereof. Therefore, the scope hereof shall be determined by the appended claims without any implied limitations thereto.

We claim:

1. A method of attaching a blast diverting shield to the bottom of a space frame vehicle subsequent to deployment of the vehicle to the field; the method comprising the steps of:
a) attaching at least one beam to an upper surface of said shield, said beam being oriented longitudinally along said shield surface;
b) installing a plurality of threaded bosses into said space frame;
c) bolting said beam to said space frame by installing bolts securing said beam to said threaded bosses in said space frame.

2. The method recited in claim 1 wherein in step a), said at least one beam is configured to collapse to deplete blast energy from beneath said blast shield.

3. The method recited in claim 1 wherein in step a), said at least one beam is configured as a collapsible tube to deplete blast energy from beneath said blast shield.

4. The method recited in claim 1 wherein in step a), said at least one beam is attached to said space frame substantially adjacent at least one of the frame rails of said vehicle.

5. The method recited in claim 1 wherein in step a), two said beams are attached to said shield, said beams being spaced apart in substantially symmetrical parallel relation.

6. The method recited in claim 1 further comprising the steps of:
d) securing brackets adjacent to opposed perpendicular edges of said shield;
e) bolting said brackets to said space frame by employing bolts into said threaded bosses that are positioned adjacent opposed peripheral edges of said space frame.

7. The method recited in claim 6 further comprising the step of:
f) interposing height adjustment shims of selected thickness between each of said brackets of step d) and each of said threaded bosses of step e).

8. The method of claim 1 wherein in step a), said shield is V-shaped.

9. The method of claim 1 wherein in step a) said shield has a parabolic shape.

10. The method of claim 1 wherein in step b), each of said threaded bosses is welded into said space frame.

11. The method recited in claim 1 further comprising the step of providing at least one adapter plate positioned between said space frame and said shield and having elongated slots for position adjustment therebetween.
